(19) United States
(12) Patent Application Publication
(10) Pub. No.: US 2019/0019226 A1
(43) Pub. Date: Jan. 17, 2019

(54) PAYMENT SYSTEM AND METHOD

(71) Applicant: Marianna BRAUN, München (DE)

(72) Inventor: Marianna BRAUN, München (DE)

(21) Appl. No.: 15/788,287

(22) Filed: Oct. 19, 2017

Related U.S. Application Data
(63) Continuation of application No. PCT/EP2017/068808, filed on Jul. 25, 2017.

(30) Foreign Application Priority Data
Jul. 14, 2017 (EP) 17181468.4

(51) Int. Cl. G06Q 30/02; G06Q 30/06; G06Q 20/20; G06Q 20/32; G06Q 20/34

(52) U.S. Cl. CPC G06Q 30/0279; G06Q 30/0213; G06Q 20/352; G06Q 20/204; G06Q 20/322; G06Q 30/0641

(57) ABSTRACT

The present invention relates to a payment system and a method. The payment system comprises at least one point of sale device for processing a transaction between a dealer and a client, the point of sale device being configured to read a payment ID assigned to the client, and to send out the payment ID further and at least a deal value, and to receive an acknowledgement signal for the transaction; at least one payment ID system for further processing the transaction, the payment ID system being configured to receive at least the payment ID and the deal value, and to check the payment on the basis of data accessible by the payment ID system, and in case of a correct data to generate and to submit the acknowledgement signal to the point of sale device, and to generate and submit at least a trigger signal; at least one communication system to submit a control signal from and to the client; at least one value adding system for receiving the trigger signal and for receiving the communication signal, the value adding system being configured to determine or receive at least one add-on value that is based on to the deal value, and to accumulate each add-on value for each deal value, and to transfer the accumulated add-on values upon receipt of the communication signal to initiate a donation to a donation system.

### CROSS-REFERENCE TO RELATED APPLICATIONS

This application is a bypass continuation of International Application No. PCT/EP2017/068808, filed Jul. 25, 2017, which claims the benefit of priority to European Application No. 17181468.4, filed Jul. 14, 2017, in the European Patent Office. All disclosures of the documents named above are incorporated herein in their entireties by reference.

### FIELD

The invention relates to a payment system and method. The payment system according to the present invention can comprise a value-add-on system that is particularly adapted to transfer an added value to a donation system.

### INTRODUCTION

At the present time, several banks offer credit/charge cards where the user benefits in some manner every time a transaction using the card is made. The user benefit may be ‘Air flight miles’ or cash, vacation or a gift. The banks or card issuing organizations use this as an incentive for the purchaser to use their credit card.

Donations are usually made to charities of all kinds, it would be new and useful if such donations and contributions could be made to a charity selected by a cardholder using a credit/charge card.

Credit/charge cards are available which identify a charity or charities to receive a donation, and a purchase processing system that processes the card user's transaction, pays a previously decided amount to the charity or charities and also bills the cardholder. In this system, the donated amounts may be paid by the bank or card issuing organization, or the cardholder may add an amount that he pays to the selected charity.

U.S. Pat. No. 8,160,922 B2 describes A method and system for making a donation to a third party, wherein a user executes a purchase transaction using a card linked to a reward point account If a user donation is desired, then the user's reward point account is decreased and corresponding value is transferred to a designated third party as a donation. In another aspect referred to as “topping off”, the donation amount is the difference between the tender amount and the purchase amount, and is transferred to a designated third party as a donation to the third party in lieu of providing change for the transaction back to the user.

U.S. Pat. No. 5,466,919 describes a method which enables a credit cardholder to make a donation to a cardholder-selected charity any time he makes a purchase using the credit card. The method comprises a credit/charge card which identifies on its magnetic strip, charities to receive a donation, and a bank expedited system which processes the card user's purchase transaction, pays a previously decided amount to the charity or charities and also bills the cardholder. In this system, the donated amounts may be paid by the bank or card issuing organization, or the cardholder may add an amount that he pays to the selected charity.

### SUMMARY

It is the object underlying the present invention to provide an improved or alternative payment system and method.

This object is attained by means of the present invention.

The present invention relates to a payment system and parts thereof. The payment system can comprise at least one point of sale device for processing a transaction between a dealer and a client. The point of sale device can be a cashier or any other electronic or computer based system, particularly for the non-cash payments of a deal between a dealer and a client. A dealer or the client can be any entity, a shop, a corporation, an individual, a legal entity, a governmental authority, a non-governmental authority, a trader, a remote trading system, an online trading platform etc.

The point of sale device can be configured to read a payment ID assigned to the client and/or can be a template for entering data of a payment card or information. The payment ID can be anything that refers or corresponds to an account with value assigned to the client. Value can be any money on an account, electronic currency, bitcoins etc. The reading of the payment ID can be done by a slot for reading magnetic information, an active or passive transponder protocol, any non-contact reading, such as by Bluethooth®, Wifi, NFC with a smart card or smart device etc.

The point of sale device can send out the payment ID and at least a deal value or amount to be paid. Other information can be transmitted as well.

The point of sale device can also receive an acknowledgement signal for the transaction that can be sent out usually but not necessarily by a remote system, as will be described in more detail.

Further provided can be at least one payment ID system for further receiving at least the payment ID and the deal value and for processing the transaction. This is usually the remote system checking the payment ID that can check the amount, the solvency or creditworthiness of the client by accessing further information, such as bank data, bank accounts, purchasing patterns of the client, currency change rates etc.

The payment ID system can be configured to check the payment on the basis of data accessible by the payment ID system as described before and below. In case of positive or correct data the payment ID system can generate and submit the acknowledgement signal to the point of sale device. It goes without saying that it can also submit a negative signal indicating that a deal is not admitted, that the payment ID is likely used illegally etc.

The payment ID system can generate and submit at least a trigger signal that will be explained in more detail.

The payment system can also comprise at least one communication system to submit a control signal from and to the client. This can be a software/hardware system allowing the client to access information or data and to interact with any of the components or systems mentioned before and below. The software component can be a software application (often abbreviated “app”) to be installed on a computer, tablet, smartphone etc.

Further contained is at least one value adding system for receiving the trigger signal and for receiving the communication signal. The value adding system can be a software/hardware system for administrating and/or controlling a special system that is provided for obtaining, diverting, accumulating etc. donations to be transferred to a donation system at some point in time, either systematically, periodically and/or an individual choice by the client.

The value adding system can be configured to determine or receive at least one add-on value that is based on the deal value. As a donation amount should become considerable, the value adding system is further configured to accumulate each add-on value for each deal value when desired. It can further transfer the accumulated add-on values upon receipt of the communication signal to initiate a donation to a donation system.

The payment ID can be comprised by at least one of a credit card, a debit card and a contactless payment system, the payment ID being preferably comprised by a credit card. Smart cards and/or smart devices, such as smartphone devices, can also make payments. The payment ID can be comprised or contained or attached to all such devices.

The ID administrator system and/or the value adding system can be configured to determine the add-on value on the basis of the deal value, wherein the add-on value is preferably 1% of the deal value. The value can be constant or can also change. In any case it is assured that the whole add-on value is available and the whole add-on value can be transferred to a donation system.

The value adding system can further comprise a value adding account for receiving a value according to each add-on value. However, the account can also be assigned to another entity, such as an escrow system.

The trigger signal generated by the payment ID system and received by the value adding system can be sent separately or together with other information, such as the add-on value. It can also be sent directly from the ID payment system to the value adding system and/or to a client account system. Any station can also modify the trigger signal until it is received by the value adding system. E.g. the ID payment system sends out a trigger signal perhaps together with a portion of the add-on value directly to the value adding system with a deal number and/or another trigger signal or kind of trigger signal to the client account system (explained further in the following). Anyhow, the client account system may then initiate the transfer of the remaining portion of the add-on value and may modify the trigger signal into the transfer information with an identification of the deal number etc. The trigger signal can also be configured to at least initiate the determination of the add-on value and to transfer the add-on value of either or both of the payment ID system (20) and the client account system (60).

A value adding fee can be derived and transferred from the payment ID system to a value adding fee account, particularly for expenses and earning of the value adding entity. The value adding fee can be a portion or fraction of a transfer fee charged by the payment ID system.

The communication system can assist the client to select at least one donation system via the communication signal. The communication system can comprise at least one of an application (app) and a graphical user interface (GUI). It can further provide the client with at least one of a status of the value adding account, a selection of donation systems, all or a portion of the accumulated add-on value to be transferred to at least one of the donation systems selected, the submission of the communication signal to the value adding system for the transfer value, the generation of a confirmation sheet of the transfer value to the donation system(s) and a news and/or chat blog.

A client account system, such as a bank account, can be further provided. The payment ID system can further comprise a payment ID account, and/or the donation system can comprise at least a donation account. Alternative escrow and/or trustee systems can also be arranged.

The add-on value can be transferred by at least one of the payment ID system and the client account system to the value adding system.

The add-on value can be taken or transferred from at least one of the payment ID account and/or the client account system so that the add-on value is either derived from a transfer fee for a deal, from the client account system or composed by both. The add-on value is composed by 5%-50%, preferably 10%-25%, more preferably 10%-20% of the transfer fee for each deal of the payment ID system and the remaining portion from the client account system. However, the add-on value of 1% of the deal value is received and accumulated by the value adding system and is collected from the client account system, according to the most preferred embodiment.

The payment system can be configured to provide push signals to the client with the status of the value adding account, a preferred selection of donation systems and the news and the chat blog about preferred donation systems etc. depending on the time and other information.

The payment system can be configured to directly or indirectly initiate and manage crowd funding of certain donation systems. Crowd funding is intended to mean an accumulation of donation of a plurality of clients. This can initiate large amounts to be donated by a group of people so that they get the feeling of to considerably help a certain project.

The communication system can be connected with one or more donation systems to provide further information for a client or more clients.

A payment ID account can be further provided that receives a payment from a client account on the basis of the deal value, wherein the payment ID system controls a payment to a dealer account in the amount of the deal value minus a transaction fee and a payment to the payment ID account in the amount of the transaction fee.

The present invention is also directed to a method. The method can comprise the following steps, also in a different order: processing a transaction between a dealer and a client by at least one point of sale device and reading a payment ID assigned to the client by the point of sale device, and sending out the payment ID and at least a deal value by the point of sale device, and receiving an acknowledgement signal for the transaction by the point of sale device. Further it can provide a processing of the transaction by at least one payment ID system, receiving at least the payment ID and the deal value by the payment ID system, and to check the payment on the basis of data accessible by the payment ID system (20), and in case of a correct data generating and submitting the acknowledgement signal to the point of sale device by the payment ID system, and generating and submitting at least a trigger signal by the payment ID system. Moreover, the method can comprise a submitting of a control signal from and to the client by at least one communication system as well as receiving the trigger signal and receiving the communication signal by at least one value adding system, at least one of determining and receiving at least one add-on value that is based on to the deal value by the value adding system, and accumulating each add-on value for each deal value by the value adding system, and transferring the accumulated add-on values upon receiving the communication signal to initiate a donation to a donation system by the value adding system.

Any features specified with respect to a device, system etc. shall be also embraced by the present specification for the respective method or method steps.

The present technology will now be discussed with reference to the accompanying drawings.

### BRIEF DESCRIPTION OF THE DRAWINGS

FIG. 1 comprises a schematic sketch of a preferred embodiment of a payment system according to the present invention.

### DESCRIPTION OF EMBODIMENTS

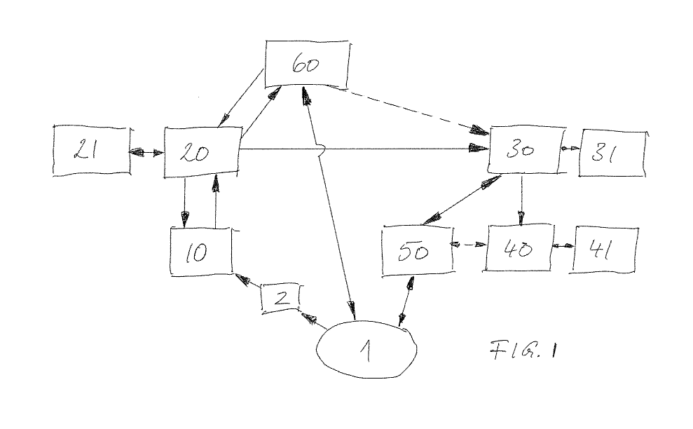

FIG. 1 schematically depicts an embodiment of the invention. A client 1 is just shown for explanatory purposes and is not embraced by the present invention.

The client 1 is holding a payment ID 2 that can be of any form as described before and claimed. The payment ID is brought to the point of sale device (10), to its vicinity or entered into a template of a point of sale system 10. The respective payment ID is read out or entered by the client.

The point of sale device takes this information and other information such as a deal value and possibly further information to a payment ID system (20). This can be a credit card company, PayPal® etc. Such payment ID systems (20) are generally automatically or semi-automatically handling and managing such deals by safeguarding the transfer of money, sometime with further conveniences to customers or clients. Usually they are taking a transfer fee for such a deal. Such transfer fees can be deposited on a payment ID account (21).

The payment ID system (20) can simultaneously or later communicate with an account system (60) assigned to the client. This usually comprises a client account for money and/or other values such as Bitcoins. In case of simultaneous or frequent communication an exchange of information is performed in order to check the parameters for a certain deal.

A value adding system (30) can communicate with the client account system (60) and/or the payment ID system (20) and can receive an add-on value from either or both of theses systems. This also applies to the respect values to be transferred to the value adding system (30). The values can then be transferred to a value adding account (31) assigned to the value adding system (30). However, alternatively or additionally the add-on values may be just controlled by the value adding systems (30) and can be transferred to a donation system (40) from the client account system (60) or the payment ID system (20) or an escrow system (not shown).

A donation account (41) can be assigned to the donation system (40). The donation system (40) can also send information to a communication system (50). The communication system (50) can be hardware/software based and can be the link to the client (1). It can also be connected to any other component of the system and is supposed to allow the client to control the payment system, to obtain information or to receive information from components of the system, e.g. by push-functions. Thus, communication system (50) can also be jointly provided to get information from or to control the client account system (60) and/or the payment ID system (20).

A value adding fee can be derived and transferred to a value adding fee account (not shown).

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A payment system comprising:
(a) a point of sale device for processing a transaction between a dealer and a client,
i. the point of sale device being configured to read a payment ID assigned to the client, and
ii. to send out the payment ID and at least one deal value, and
iii. to receive an acknowledgement signal for the transaction;
(b) a payment ID system for further processing the transaction,
iv. the payment ID system being configured to receive at least the payment ID and the deal value, and
v. to check the payment on the basis of data accessible by the payment ID system, and
vi. in case of a correct data to generate and to submit the acknowledgement signal to the point of sale device, and
vii. to generate and submit a trigger signal;
(c) a communication system to submit a control signal from and to the client;
(d) a value adding system for receiving the trigger signal and for receiving the communication signal,
viii. the value adding system being configured to determine or receive at least one add-on value that is based on the at least one deal value, and
ix. to accumulate each add-on value for each deal value, and
x. to transfer the accumulated add-on values upon receipt of the communication signal to initiate a donation to a donation system.

2. The payment system according to claim 1 wherein the payment ID comprises at least one of a credit card, a debit card and a contactless payment system.

3. The payment system according to claim 1, wherein at least one of the ID administrator system and the value adding system is configured to determine the add-on value on the basis of the deal value.

4. The payment system according to claim 1, wherein the trigger signal generated by the payment ID system and received by the value adding system is configured to identify the add-on value or portions thereof or to initiate the determination of the add-on value and to transfer the add-on value of either or both of the payment ID system and the client account system and to be sent separately or together with the add-on value information.

5. The payment system according to claim 1, wherein a value adding fee is derived and transferred from the payment ID system to a value adding fee account, the value adding fee being a portion of a transfer fee charged by the payment ID system from the deal amount.

6. The payment system according to claim 1, the value adding system further comprising a value adding account for receiving a value according to each add-on value.

7. The payment system according to claim 1, wherein the communication system assists the client to select at least one donation system via the communication signal.

8. The payment system according claim 6, wherein the communication system comprises at least one of an application (app) and a graphical user interface (GUI) providing the client with at least one of a status of the value adding account, a selection of donation systems, all or a portion of the accumulated add-on value to be transferred to at least one of the donation systems selected, the submission of the communication signal to the value adding system for the transfer value, the generation of a confirmation sheet of the transfer value to the donation system(s) and a news and chat blog.

9. The payment system according to claim 1, wherein the payment system further comprises a client account system, the payment ID system further comprising a payment ID account, and/or the donation system comprising at least a donation account.

10. The payment system according to claim 1, wherein the add-on value is transferred by at least one of the payment ID system and the client account system to the value adding system.

11. The payment system according to claim 1, wherein the add-on value is taken from at least one of the payment ID account and the client account system so that the add-on value is either derived from the transfer fee for a deal, from the client account system or composed by both.

12. The payment system according to claim 1, wherein the add-on value is composed by 5%-50%, of the transfer fee for each deal of the payment ID system and the remaining portion from the client account system.

13. The payment system according to claim 8, wherein the payment system is configured to provide push signals to the client with the status of the value adding account, a preferred selection of donation systems and the news and the chat blog about the preferred donation systems depending on the time.

14. The payment system according to claim 1, wherein the payment system is configured to directly or indirectly initiate and manage crowd funding of certain donation systems.

15. The payment system according to any of the preceding claims wherein the communication system can be connected with one or more donation systems to provide further information for a client or clients.

16. The payment system according to claim 1, further comprising a payment ID account that receives a payment from a client account on the basis of the deal value, wherein the payment ID system controls a payment to a dealer account in the amount of the deal value minus a transaction fee and a payment to the payment ID account in the amount of the transaction fee.

17. A method of payment with the payment system according to claim 1, comprising:
(e) processing a transaction between a dealer and a client by the sale device and
xi. reading the payment ID assigned to the client by the point of sale device, and
xii. sending out the payment ID and the deal value by the point of sale device, and
xiii. receiving the acknowledgement signal for the transaction by the point of sale device;
(f) further processing the transaction by the payment ID system,
xiv. receiving the payment ID and the deal value by the payment ID system, and
xv. to check the payment on the basis of data accessible by the payment ID system, and
xvi. in case of a correct data generating and submitting the acknowledgement signal to the point of sale device by the payment ID system, and
xvii. generating and submitting the trigger signal by the payment ID system;
(g) submitting the control signal from and to the client by the communication system;
(h) receiving the trigger signal and receiving the communication signal by the value adding system,
xviii. at least one of determining and receiving the add-on value that is based on to the deal value by the value adding system, and
xix. accumulating each add-on value for each deal value by the value adding system, and
xx. transferring the accumulated add-on values upon receiving the communication signal to initiate the donation to the donation system by the value adding system.
